(19) United States
(12) Patent Application Publication
(10) Pub. No.: US 2006/0208104 A1
(43) Pub. Date: Sep. 21, 2006

(54) Handheld shower sprayer dual temperature sprays and additive intermixing

(75) Inventors: Jeffrey A. DeBoer, Ann Arbor, MI (US); Aaron Hughes, San Francisco, CA (US)

Correspondence Address: CARLSON, GASKEY & OLDS, P.C., 400 WEST MAPLE ROAD, SUITE 350, BIRMINGHAM, MI, 48009, US

(73) Assignee: Alsons Corporation

(21) Appl. No.: 11/081,128

(22) Filed: Mar. 16, 2005

(51) Int. Cl. B05B 7/30; B05B 7/26; A62C 31/00; B05B 9/01

(52) U.S. Cl. 239/318; 239/310; 239/443; 239/525

(57) ABSTRACT

A handheld shower sprayer system includes a first spray nozzle and a second spray nozzle with separate fluid supplies to provide a dual temperature spray or, alternatively to mist steam either simultaneous with, or separate from, water sprayed from the first spray nozzle. A reservoir stores a skin treatment liquid additive such as vitamins, minerals, herbs, oils, aromatic liquids, moisturizers or lotions which is selectively communicated with the second spray nozzle to intermix the skin treatment liquid with the second fluid.

### BACKGROUND OF THE INVENTION

The present invention relates to a handheld sprayer, and more particularly to a handheld shower sprayer which incorporates skin conditioning features.

Attaining a fresh-appearing, youthful-looking, wrinkle-free facial skin has been a goal sought throughout recorded history, and many cosmetic treatments, as well as surgical procedures, have been provided in an attempt to attain such a goal. Surveys have consistently determined that consumers desire products that promote wellness, relaxation and youth preservation. More and more, such consumers desire enhanced showers which provide bathing and skin care experiences in the home that have heretofore only been available at a spa.

Oversized luxury showers and tubs are becoming increasing desirable in new construction and bathroom renovations. Such typically include one or more multi-function showerheads. Disadvantageously, conventional handheld sprayers fail to provide features specific to skin care. These showers will also often include handheld shower sprayers. A wide variety of handheld shower sprayer systems are currently available. Conventional handheld sprayers typically provide a plurality of spray modes, including various standard sprays and pulsed sprays.

Accordingly, it is desirable to provide a handheld sprayer which provides a variety of skin care features.

### SUMMARY OF THE INVENTION

A handheld sprayer system according to the present invention includes a first spray nozzle which sprays water from a first water supply conduit and a second spray nozzle adjacent the first spray nozzle which communicates a fluid from a second conduit. The second conduit supplies water at a second temperature to provide a dual temperature spray or, alternatively mists steam either simultaneous with, or separate from, water sprayed from the first spray nozzle.

A reservoir stores a skin treatment liquid additive such as vitamins, minerals, herbs, oils, aromatic liquids, moisturizers or lotions which is selectively communicated with the second spray nozzle to intermix the skin treatment liquid with the second fluid. Intermixing of skin treatment liquids with steam is particularly advantageous in facial and skin care to facilitate exfoliation, hydration, moisturization and the increase of blood circulation.

The present invention therefore provides a handheld sprayer which provides a variety of skin care features.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view a handheld sprayer designed according to the present invention; and

FIG. 2 is a schematic view of the handheld sprayer.

### DETAILED DESCRIPTION OF THE PREFERRED EMBODIMENT

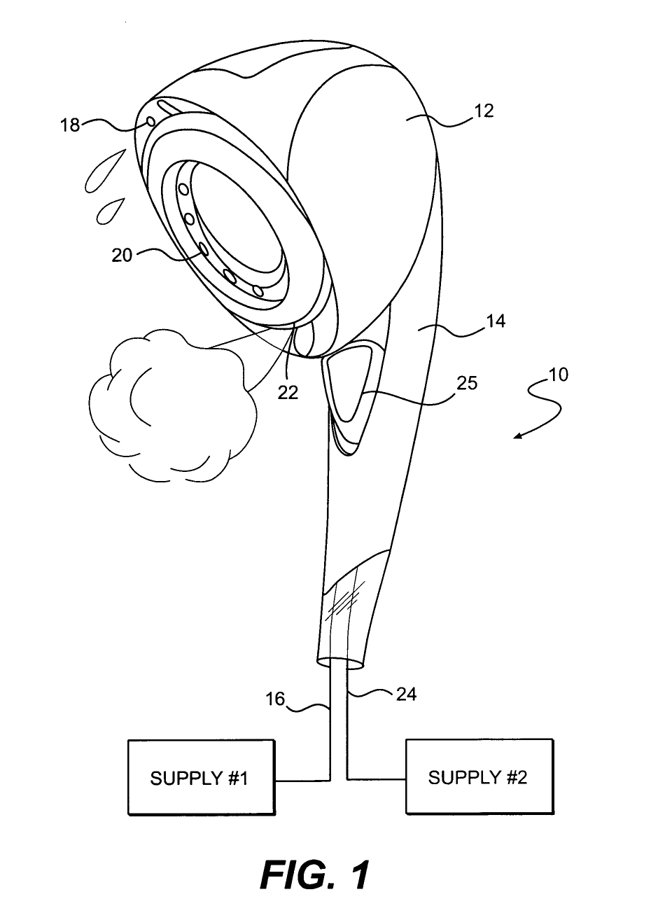

FIG. 1 illustrates a general perspective view of a handheld sprayer system 10. The system 10 includes a spray head 12 having a handle 14 which connects to a water supply conduit 16 as generally understood. The spray head 12 includes a spray nozzle side 18 having a first spray nozzle 20 which sprays water from the water supply conduit 16. A second spray nozzle 22 adjacent the first spray nozzle 20 communicates a fluid from a second conduit 24.

The second conduit 24 preferably supplies water at a second temperature to provide a dual temperature spray. The separate temperature water supplies are preferably provided from separate water sources integrated into a sink, a shower or tub surround to which the handheld sprayer system 10 is connected. Dual temperature sprays are particularly advantageous in hydrotherapy treatments that alternate between relatively cool water and relatively hot water. By providing multiple sprays with such a thermal variation from a single handheld system, the bathing experience is readily increased. That is, each of a multiple of sprays, each at a different temperature is readily available by, for example, actuation of a particular control trigger (illustrated schematically at 25).

The second conduit 24 may alternatively mist steam either simultaneous with, or separate from, water sprayed from the first spray nozzle 20. Such steam supply has been determined to detoxifies the body and face through perspiration and the opening of pores. Such a steam supply is particularly advantageous for facial treatments and care.

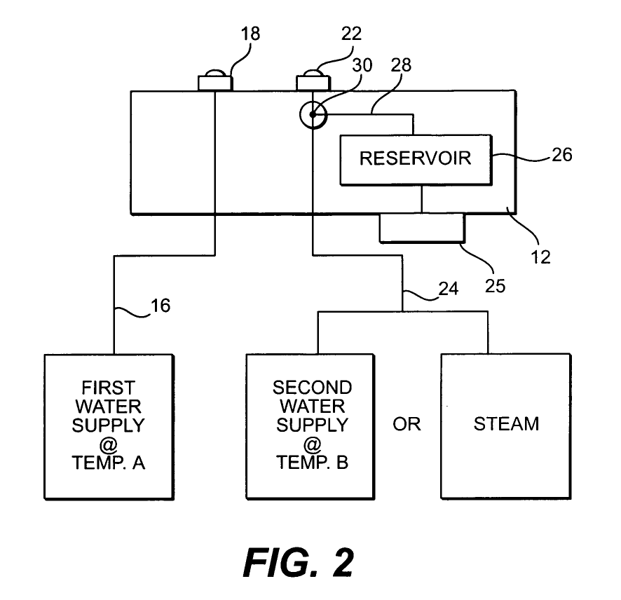

Referring to FIG. 2, the handheld sprayer system 10 is schematically illustrated. In addition to the water supply conduit 16 and the second conduit 24, a reservoir 26 is preferably contained within the spray head 12. The reservoir 26 preferably stores a skin treatment liquid additive such as vitamins, minerals, herbs, oils, aromatic liquids, moisturizers or lotions. It should be understood that various facial, body and other treatment liquids may be usable with the present invention.

The reservoir 26 selectively communicates with the second spray nozzle 22 to intermix the skin treatment liquid with the second fluid. Intermixing of skin treatment liquids with steam is particularly advantageous in facial and skin care to facilitate exfoliation, hydration, moisturization and the increase of blood circulation.

Preferably, the reservoir 26 selectively communicates with the second spray nozzle 22 through a conduit 28 and mix valve 30 which selectively injects the skin treatment liquid in response to activation of the trigger control 25. The admixture of ingredients into the second spray nozzle includes injecting air into the water stream and preferably generally functions in accordance with the venturi principle. One of ordinary skill in the art will readily be able to provide dispensing controls to inject the skin treatment liquid into the second spray in combination with the teachings disclosed herein.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A handheld shower sprayer system, comprising:
a handheld shower sprayer for spraying a shower of water from a first nozzle, said first nozzle located within a nozzle section adjacent a handle section;
a second nozzle which supplies a second fluid at a temperature different than said shower of water, said second nozzle located within said nozzle section; and
a trigger located at an intersection of said nozzle section and said handle section to control the supply of said shower of water and said second fluid.

2. The handheld shower sprayer system as recited in claim 1, wherein said second fluid includes steam.

3. The handheld shower sprayer system as recited in claim 1, wherein said second fluid is supplied simultaneous with said shower of water.

4. The handheld shower sprayer system as recited in claim 1, further comprising a reservoir contained with said handheld shower sprayer which intermixes an additive to said second fluid.

5. The handheld shower sprayer system as recited in claim 4, wherein said additive includes an oil.

6. The handheld shower sprayer system as recited in claim 4, wherein said additive includes a fragrance.

7. A handheld shower sprayer system, comprising:
a handheld shower sprayer for spraying a shower of water from a first nozzle;
a second nozzle which supplies a second fluid at a temperature different than said shower of water; and
a reservoir within said handheld shower sprayer which intermixes an additive to said second fluid.

8-9. (canceled)

10. A handheld shower sprayer system, comprising:
a nozzle section having a nozzle surface and a cover portion opposite said nozzle surface, said nozzle section disposed upon a handle section;
a first nozzle for spraying a shower of water, said first nozzle located upon said nozzle surface of said nozzle section;
a second nozzle which supplies a second fluid at a temperature different than said shower of water, said second nozzle located upon said nozzle surface of said nozzle section; and
a trigger operative to control supply of said second fluid, wherein said trigger is located adjacent the intersection of said nozzle section and said handle, and adjacent said nozzle surface.

11. (canceled)

12. The handheld shower sprayer system as recited in claim 10, comprising a reservoir within said nozzle section which intermixes an additive to said second fluid

13. (canceled)

14. The handheld shower sprayer system as recited in claim 10, wherein said trigger is located on said handle.

15. The handheld shower sprayer system as recited in claim 14, wherein said trigger and said nozzle surface face the same direction.

16. The handheld shower sprayer system as recited in claim 14, wherein said trigger faces the direction of spray of the shower of water from the first nozzle.

17-20. (canceled)
